(19) United States
(12) Patent Application Publication
(10) Pub. No.: US 2015/0163352 A1
(43) Pub. Date: Jun. 11, 2015

(54) METHOD AND DEVICES FOR IDENTIFYING THE CALLER OF AN EMERGENCY CALL

(71) Applicants: Moritz Ritter, Erlenbach (CH); Pascal König, Zurich (CH)

(72) Inventors: Moritz Ritter, Erlenbach (CH); Pascal König, Zurich (CH)

(21) Appl. No.: 14/343,259

(22) PCT Filed: Aug. 29, 2012
(86) PCT No.: PCT/CH2012/000205

§ 371 Date: Jun. 20, 2014

(30) Foreign Application Priority Data
Sep. 8, 2011 (CH) 01484/11

(51) Int. Cl. H04M 3/42; H04W 4/22

(52) U.S. Cl. CPC H04M 3/42042; H04W 4/22

(57) ABSTRACT

A personal mobile emergency call device (1), comprises a subscriber identification module (15) having stored therein a mobile subscriber identity for registering and identifying a user of the personal emergency call device (1) in a mobile radio network (3), and an alarm module (11) configured to execute on behalf of the user an emergency call via the mobile radio network (3) to a computerized central service unit (2). The alarm module (11) is further configured to transmit in association with the emergency call automatically to the central service unit (2) via the mobile radio network (3) a personal emergency call device identifier (112) stored in the personal emergency call device (1) for identifying non-ambiguously the personal emergency call device (1) and its user at the central service unit (2). The alarm module transmits the emergency using informations redundancy, i.e. forward error correction and communication redundancy, i.e transmission via multiple communication channels in parallel.

### FIELD OF THE INVENTION

The present invention relates to a method and devices for identifying the caller of an emergency call. Specifically, the present invention relates to a method for identifying the caller of an emergency call, a personal mobile emergency call device for executing the emergency call to a computerized central service unit via a mobile radio network, and to a computerized service unit for receiving the emergency call over the mobile radio network.

### BACKGROUND OF THE INVENTION

In a personal security or emergency call system, a personal security or emergency call device is used to trigger an alarm. The personal emergency call device executes an emergency call on behalf of its user and communicates with a computerized emergency service platform. The emergency service platform initiates actions for providing support to the person in need.

WO 2009/109642 describes a mobile personal security or emergency call device having an element for triggering an emergency call via mobile radio communication. According to WO 2009/109642, upon having been triggered, the mobile personal security or emergency call device initiates an emergency call via a mobile radio network to an emergency call center. According to WO 2009/109642, the emergency call center forwards the emergency call to defined telephone numbers.

U.S. Pat. No. 6,151,385 describes a 911-emergency call system which is based on the Automatic Number Identification (ANI) of the calling number. According to U.S. Pat. No. 6,151,385 communication addresses are associated with the calling number of registered subscribers and when an emergency call is received, the calling number is determined through ANI and the communication addresses associated with the calling number are contacted automatically. U.S. Pat. No. 6,151,385 further teaches that instead of a calling number a more personal information address could be used to represent an information transfer device.

WO 2007/087077 describes another 911-emergency call system. According to WO 2007/087077, an agent arranged within a mobile telephone transmits to a central server a Service Set Identifier (SSID) at the same time as the 911-emergency call is initiated. The SSID makes it possible to identify and load medical information associated with the subscriber placing the 911-emergency call.

Typically, telephone networks, including mobile radio telephone networks, are configured to determine and provide the telephone number of the caller as the identity of the caller, i.e. the Caller ID or CLID. However, not all network operators provide the Caller ID. Moreover, across national borders the transmission of the Caller ID is not reliable, because the first or last digit or digits of the telephone number may be truncated, or the Caller ID is not transmitted across the border at all. For personal security or emergency call systems, it is absolutely essential, however, that the personal security or emergency call device or its user, respectively, be identified non-ambiguously.

### SUMMARY OF THE INVENTION

It is an object of this invention to provide a method and devices for identifying the caller of an emergency call, which method and devices do not have at least some of the disadvantages of the prior art. In particular, it is an object of the present invention to provide a method and devices for identifying the caller of an emergency call non-ambiguously across national boundaries, where the caller ID may be incomplete or missing altogether.

According to the present invention, these objects are achieved through the features of the independent claims. In addition, further advantageous embodiments follow from the dependent claims and the description.

A personal mobile emergency call device comprises a subscriber identification module having stored therein a mobile subscriber identity for registering and identifying a user of the personal emergency call device in a mobile radio network. The personal emergency call device further comprises an alarm module configured to establish via the mobile radio network on behalf of the user a connection for an emergency call to a computerized central service unit.

According to the present invention, the above-mentioned objects are achieved in that the personal mobile emergency call device further comprises a data store having stored therein a personal emergency call device identifier, and that the alarm module of the personal mobile emergency call device is further configured to transmit, in association with the emergency call, automatically and with information redundancy and/or communication redundancy, to the central service unit via the mobile radio network the personal emergency call device identifier for identifying non-ambiguously the personal emergency call device which represents its user at the central service unit. Thus, the personal emergency call device and thereby its user can be identified reliably at the central service unit using the personal emergency call device identifier which is separate and independent of any ANI or CLID or mobile subscriber identity that may or may not be provided correctly by the respective communication network used for transmitting the emergency call.

In various embodiments and/or configurations, the alarm module is configured to transmit the personal emergency call device identifier with communication redundancy by transmitting the personal emergency call device identifier to the central service unit via more than one communication channel, the communication channels including a voice channel of the mobile radio network, a packet oriented data channel of the mobile radio network, a signaling channel of the mobile radio network, a Short Messaging Service of the mobile radio network, and/or an Unstructured Supplementary Service Data connection of the mobile radio network.

In an embodiment, the alarm module is configured to include in the emergency call a unique alarm identification number, to transmit the personal emergency call device identifier with communication redundancy by transmitting the personal emergency call device identifier to the central service unit via at least one different communicational channel than the emergency call, and to append to the personal emergency call device identifier the unique alarm identification number, for assigning the emergency call at the central service unit to the personal emergency call device identifier.

In a further embodiment, the alarm module is configured to transmit the personal emergency call device identifier with information redundancy by transmitting the personal emergency call device identifier to the central service unit encoded as tones via a voice channel of the mobile radio network and including redundant information for forward error correction.

The computerized service unit comprises an alarm processor configured to receive from the personal mobile emergency call device via a mobile radio network an emergency call on behalf of the user of the personal emergency call device, the user being registered in the mobile radio network with the mobile subscriber identity provided by the personal mobile emergency call device.

According to the present invention, the above-mentioned objects are further achieved in that the alarm processor is further configured to receive via the mobile radio network a personal emergency call device identifier transmitted, automatically and with information redundancy and/or communication redundancy, by the personal mobile emergency call device to the computerized central service unit in association with the emergency call, and to identify non-ambiguously the personal emergency call device and its user using the personal emergency call device identifier.

In various embodiments and/or configurations, the alarm processor is configured to receive the personal emergency call device identifier with communication redundancy by receiving the personal emergency call device identifier via more than one communication channel, the communication channels including a voice channel of the mobile radio network, a packet oriented data channel of the mobile radio network, a signaling channel of the mobile radio network, a Short Messaging Service of the mobile radio network, and/or an Unstructured Supplementary Service Data connection of the mobile radio network.

In an embodiment, the alarm processor is configured to receive the personal emergency call device identifier with communication redundancy by receiving the personal emergency call device identifier via at least one different communicational channel than the emergency call, and to assign the emergency call to the personal emergency call device identifier using a unique alarm identification number which is included in the emergency call and appended to the personal emergency call device identifier.

In a further embodiment, the computerized service unit comprises a plurality of dial-in nodes, each dial-in node having assigned thereto one or more personal emergency call devices. The dial-in nodes are configured in each case to define a value for one or more digits of a calling number assigned to one of the personal emergency call devices upon receiving the emergency call from the one of the personal emergency call devices. For example, a dial-in node is defined by values of one or more digits of the calling number assigned to the personal mobile emergency call device.

The personal mobile emergency call device and the computerized service unit form a system for identifying a caller of an emergency call received at the computerized central service unit via a mobile radio network from the personal mobile emergency call device.

For identifying at the computerized central service unit the caller of the emergency call, received via the mobile radio network from the personal mobile emergency call device on behalf of the caller, the caller being registered in the mobile radio network with a mobile subscriber identity provided by the personal mobile emergency call device, received at the computerized central service unit via the mobile radio network is a personal emergency call device identifier transmitted to the computerized central service unit, automatically and with information redundancy and/or communication redundancy, by the personal mobile emergency call device, in association with the emergency call, and the caller of the emergency call is identified non-ambiguously using the personal emergency call device identifier.

In addition to the personal mobile emergency call device, the computerized service unit, and a method for identifying at a computerized central service unit the caller of an emergency call received via a mobile radio network from a personal mobile emergency call device, the present invention also relates to computer program products comprising computer readable media having stored therein computer program code for directing the personal mobile emergency call device and/or the computerized service unit.

### BRIEF DESCRIPTION OF THE DRAWINGS

The present invention will be explained in more detail, by way of example, with reference to the drawings in which:

FIG. 1: shows a block diagram illustrating schematically a system comprising a mobile communication device, configured as a personal mobile emergency call device, and a computerized service unit which are interconnected via a mobile radio network.

FIG. 2: shows a flow diagram illustrating an exemplary sequence of steps for identifying the caller of an emergency call, received via a mobile radio network, from a personal mobile emergency call device.

FIG. 3: shows a flow diagram illustrating an exemplary sequence of steps for monitoring the battery status of a battery included in a mobile communication device.

### DETAILED DESCRIPTION OF THE PREFERRED EMBODIMENTS

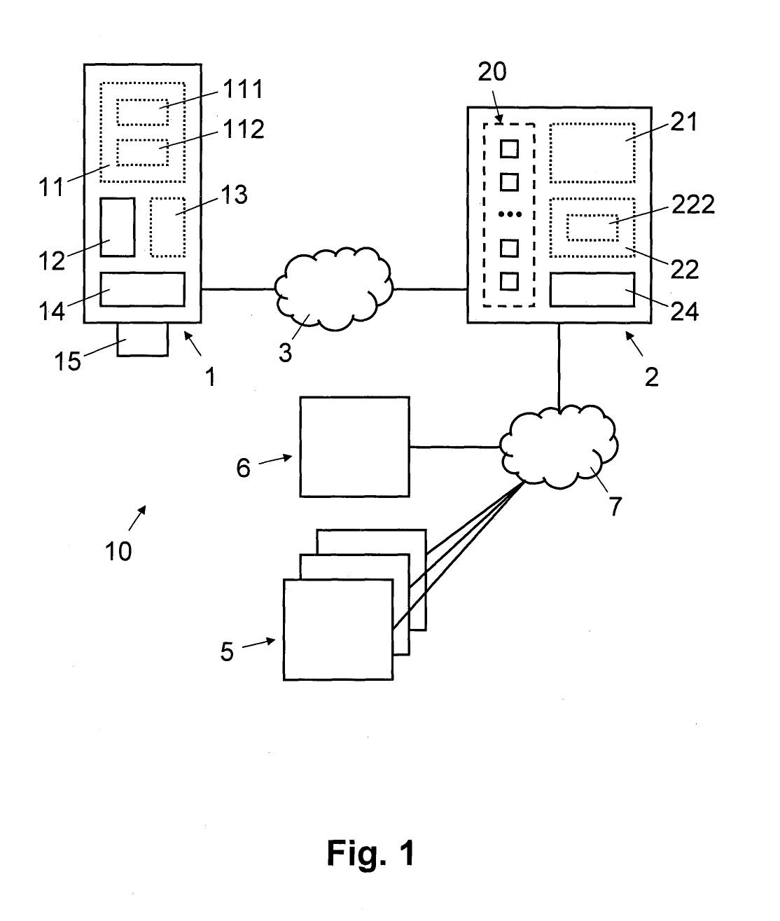

In FIGS. 1-3, reference numeral 1 refers to a mobile communication device, reference numeral 2 refers to a computerized central service unit 2, and reference numeral 5 refers to other communication terminals or communication partners, respectively.

The mobile communication device 1 comprises a communication module 14 configured for data and voice communication via a mobile radio network 3, e.g. a GSM-network (Global System for Mobile communications), a UMTS-network (Universal Mobile Telephone System), or another terrestrial or satellite-based mobile radio telephone system. The mobile communication device 1 comprises a subscriber identity module (SIM) 15 which has stored therein a subscriber identity for personalizing the mobile communication device 1. For example, the subscriber identity is an International Mobile Subscriber Identity (IMSI) for registering and identifying the user of the mobile communication device 1 as a subscriber of the mobile radio network 3. The mobile communication device 1 further comprises a rechargeable battery 12, accumulator, or other energy store for electrically powering the mobile communication device 1.

As illustrated schematically in FIG. 1, the mobile communication device 1 comprises further functional modules, specifically, an alarm module 11 and/or a battery monitoring system 13. As will be described below in more detail, the alarm module 11 is configured to establish via the mobile radio network 3 a connection for an emergency call to the computerized central service unit 2. The battery monitoring system 13 is configured to monitor the battery 12 and transmit via the mobile radio network 3 battery status reports to the computerized central service unit 2. In the configuration with the alarm module 11, the battery powered mobile communication device 1 constitutes a personal mobile emergency call device 1 which is preferably implemented as a wearable device, such as a wrist watch or a bracelet, or as another portable device for triggering a personal alarm via the mobile radio network 3, such as a mobile phone or another mobile communication terminal. For voice communication via an established (emergency) call, the mobile communication device or personal emergency call device 1, respectively, may include a speaker and a microphone. As indicated by reference numeral 10, the personal emergency call device 1 and the central service unit 2 make up a personal emergency call system. The battery monitoring system 13 is particularly useful as part of the personal mobile emergency call device 1; nevertheless, as one skilled in the art will understand, the battery monitoring system 13 also operates in battery powered mobile communication devices 1 which are not provided with an alarm module 11.

In connection with the alarm module 11, the mobile communication devices 1 comprises an alarm trigger 111 and a personal emergency call device identifier 112 which is stored in a data store of the mobile communication device or personal emergency call device 1, respectively. The alarm trigger 111 is an operating element such as a button, a switch, a key, a pressure, inductive, capacitive, optical or resistive sensor, or another means enabling the user to trigger manually a personal alarm. In an embodiment, the alarm trigger 111 is configured to trigger a personal alarm automatically depending on defined alarm conditions on defined data or parameter values measured at the mobile communication device or personal emergency call device 1, respectively, e.g. using acceleration, altitude, motion, heart rate, pulse frequency, blood pressure, body temperature, and/or oxygen saturation sensors. The personal emergency call device identifier 112 is a unique alphanumeric code for identifying non-ambiguously the personal emergency call device 1 and its user at the central service unit 2. Accordingly, the personal emergency call device identifier 112 is stored at the central service unit 2 assigned to the user who is defined by personal data, such as name, address, identification number(s), birth date, etc., or device-specific data such as shift number, area of use, etc. in case of use in professional organizations.

The central service unit 2 comprises one or more operational computers including one or more processors connected to program and data memory. The central service unit 2 comprises a communication module 24 configured to communicate via the mobile radio network 3 with a plurality of mobile communication devices or personal emergency call devices 1, respectively. The communication module 24 is further configured to communicate via telecommunications network 7 with other communication terminals or communication partners 5. In addition, the communication module 24 makes it possible to access the central service unit 2 through the telecommunications network 7 via a web interface 6. The telecommunications network 7 comprises fixed and/or mobile networks and the Internet. The web interface 6 is configured to enable the user to define in the central service unit 2 emergency contact numbers, emergency actions, emergency processing, and other settings for his/her personal emergency call devices 1.

As illustrated schematically in FIG. 1, the central service unit 2 comprises further functional modules, specifically, an alarm processor 21 and/or a battery analyzer 22. The alarm processor 21 is configured to receive and process emergency calls from the personal emergency call device 1. The battery analyzer 22 is configured to receive battery status reports from the mobile communication device or personal emergency call device 1, respectively, and to store and analyze respective battery data 222. In an embodiment, the central service unit 2 comprises a plurality of dial-in nodes 20 making it possible to receive emergency calls addressed to different called numbers assigned in each case to the dial-in nodes 20.

Preferably, the functional modules are implemented as programmed software modules comprising computer program code for directing the processors of the central service unit 2 or the mobile communication device or personal emergency call device 1, respectively. One skilled in the art will understand, however, that in alternative embodiments, the functional modules may be implemented fully or partly by way of hardware components.

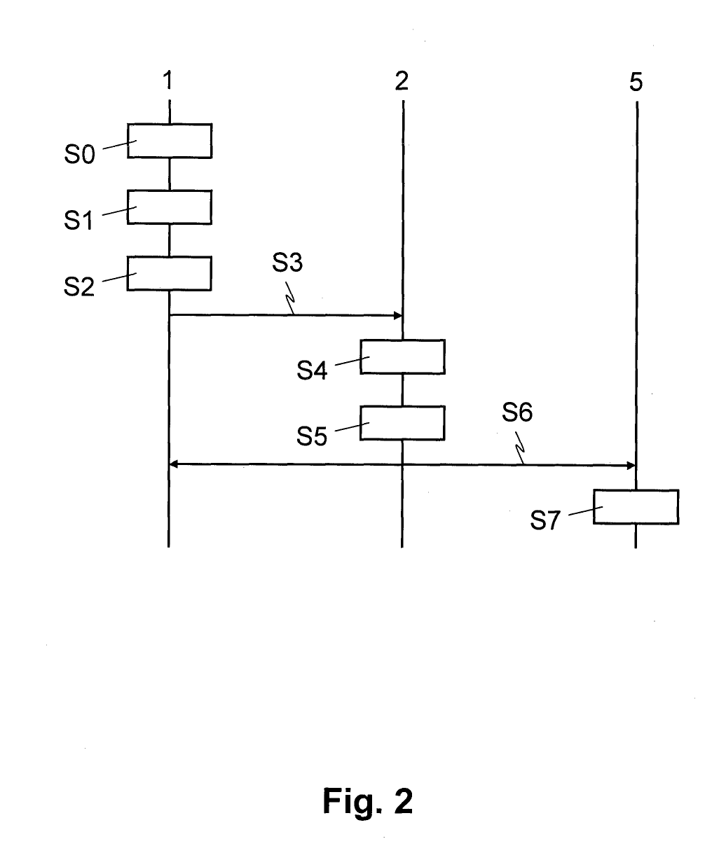

In the following paragraphs, described with reference to FIG. 2 are possible sequences of steps performed by the functional modules for identifying at the central service unit 2 the caller of an emergency call received via the mobile radio network 3 from the personal mobile emergency call device 1.

In preparatory step S0, the personal mobile emergency call device 1 is activated and registered with the mobile radio network 3. Accordingly, the mobile subscriber identity is registered with a Home Location Register (HLR) of the mobile radio network 3.

In step S1, responsive to user actions and/or current values of user parameters, the alarm trigger 111 triggers a personal alarm.

In step S2, responsive to the alarm trigger 111, the alarm module 11 executes an emergency call to the central service unit 2. Depending on the embodiment and/or configuration of the personal mobile emergency call device 1, the emergency call includes the establishment of a voice connection, for an emergency telephone call, or simply the transmission of an emergency call message. In addition, depending on the embodiment, the initiation of an emergency call includes generating one or more accompanying alarm messages assigned to the emergency call. The accompanying alarm messages include in each case the personal emergency call device identifier 112 and an alarm identification number. Accordingly, the personal emergency call device identifier 112 is transmitted to the central service unit 2 with communication redundancy, i.e. via multiple communication channels, at least one of the communication channels being different than the communication channel used for the emergency call. For example, the alarm identification number includes a sequential alarm number generated by the alarm module 11, e.g. in combination with a current date and time value. In the emergency call, the alarm identification number is transmitted over the voice channel and encoded as tones, preferably including redundant information for forward error correction. For example, the alarm identification number is encoded as Dual-tone multi-frequency (DTMF) or modem tones, e.g. according to ITU-T (International Telecommunication Union Telecommunication Standardization Sector) recommendations V.90/V.92. In an embodiment, the emergency call and/or the accompanying alarm messages include geographical location information, e.g. the current location of the personal mobile emergency call device 1 determined by way of a GPS receiver in the device 1 or from base station identifiers or other network information provided by the mobile radio network 3.

In step S3, the connection for the emergency call is set up with the central service unit 2, and, if applicable, the accompanying alarm messages are transmitted via the mobile radio network 3 to the central service unit 2.

If the central service unit 2 is provided with different dial-in nodes 20, the emergency call is addressed to the dial-in node assigned to the personal mobile emergency call device 1 or its telephone number (e.g. its MSISDN), respectively. The assignment of dial-in nodes to different telephone numbers depends on one or more defined digits of the telephone numbers, e.g. one or more leading and/or trailing digits. For example, the last two digits of the MSISDN assigned to the personal mobile emergency call device 1 define a specific one of the dial-in nodes 20 of the central service unit 2.

Depending on embodiment and/or configuration of the device 11, the accompanying alarm messages are transmitted redundantly to the central service unit 2 via different communication channels, e.g. over the voice channel of the mobile radio network 3, via a packet oriented data channel of the mobile radio network 3 such as GPRS (General Packet Radio Service), through a signalling channel of the mobile radio network 3, via a Short Messaging Service (SMS) of the mobile radio network 3 as an SMS message, and/or via Unstructured Supplementary Service Data (USSD) as an USSD message of the mobile radio network 3. For transmitting the personal emergency call device identifier 112 or the accompanying alarm message, respectively, via the voice channel to the central service unit 2, the personal emergency call device identifier 112 or the accompanying alarm message is encoded as tones, e.g. as outlined above in the context of the alarm identification number (e.g. as DTMF or modem tones), and includes redundant information for forward error correction. Thus, the personal emergency call device identifier 112 or the accompanying alarm message, respectively, is provided with redundant information for forward error correction, before it is encoded as tones and, subsequently, transmitted with information redundancy to the central service unit 2 to increase transmission reliability.

In step S4, the alarm processor 21 receives the emergency call on behalf of the user of the personal mobile emergency call device 1 and performs an identification process for determining the identity of the calling user or its device 1, respectively. Depending on the embodiment and/or emergency configurations for the personal mobile emergency call device 1 in the central service unit 2, the identification process uses the caller ID, provided by the mobile radio network 3 for the registered subscriber, and the personal emergency call device identifier 112, received in the emergency call via the voice channel or in one or more separate accompanying alarm messages. If the central service unit 2 is provided with multiple dial in nodes 20, one or more defined digits of the caller ID are determined—or verified—based on the dial-in node over which the emergency call was received, e.g. a first dial-in node defines the last two digits as “00”, a second dial in-node defines the last two digits as “01” etc. Preferably, however, the identification process relies on the personal emergency call device identifier 112 received with the emergency call and/or in separate accompanying alarm messages. If the personal emergency call device identifier 112 is received in a separate accompanying alarm message, it is assigned to the emergency call based on the alarm identification number transmitted with the emergency call and included in the respective accompanying alarm message.

In step S5, for further processing of the emergency call, the alarm processor 21 retrieves from a local database of the central service unit 2 emergency contact numbers, emergency actions, and emergency processing steps defined for the determined personal mobile emergency call device 1 or its user, respectively.

In step S6, according to the defined emergency processing, the alarm processor 21 performs any defined processing steps, and establishes emergency call connections and/or transmits emergence messages on behalf of the user with and to various emergency contacts 5 via the telecommunications network 7.

In step S7, the emergency contacts 5 will initiate and perform any emergency actions for the user. Emergency actions include, for example, setting up a voice connection with the personal mobile emergency call device 1.

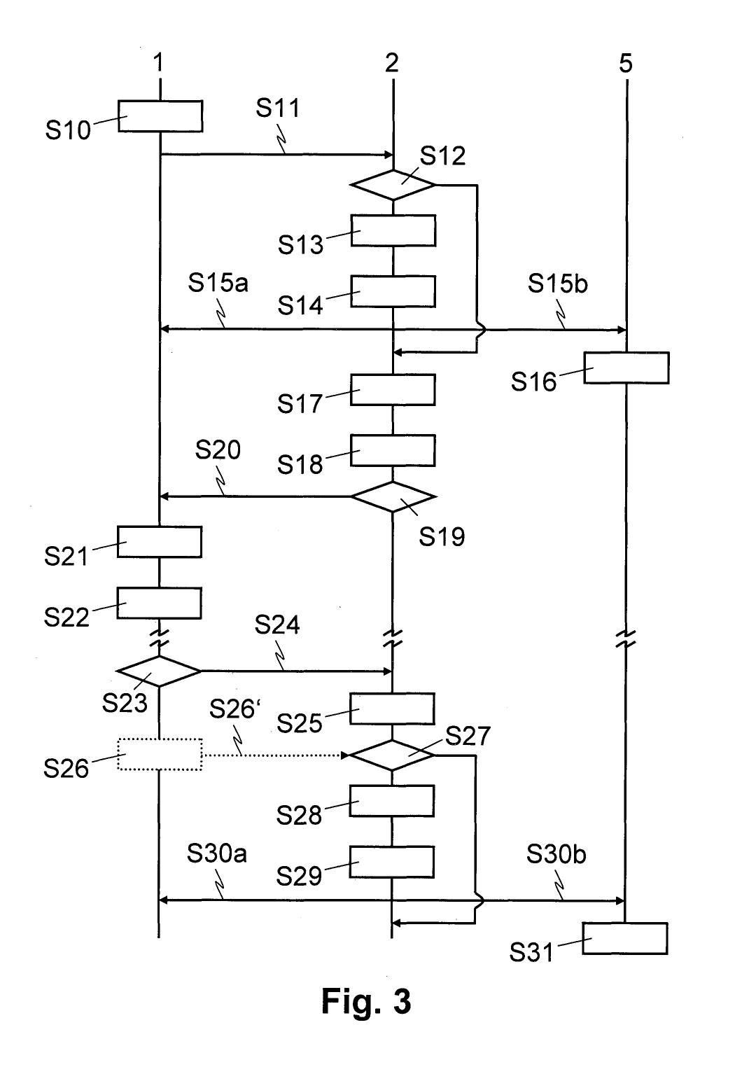

In the following paragraphs, described with reference to FIG. 3 are possible sequences of steps performed by the functional modules for monitoring the battery status of the battery 12 of the mobile communication device or personal emergency call device 1, respectively. For better clarity, in the following paragraphs, the mobile communication device or personal mobile emergency call device 1, respectively, are simply referred to as device 1.

In step S10, the battery monitoring system 13 of the device 1 generates a battery status report regarding the current status of the battery 12. For example, battery status reports are generated periodically and/or triggered by defined events such as an emergency call or low battery alarm, start and end of recharging the battery 12, replacing the battery 12, entering and leaving a stand-by mode of the device 1, or timeouts defined by the central service unit 2.

Accordingly, a battery status report includes current values of battery parameters and, depending on the situation or embodiment, event-specific information such as the time when recharging of the battery 12 started, the time when recharging of the battery 12 was completed or ended, the time when the battery 12 was installed, the time when a stand-by mode of the device 1 was turned on, and the time when the stand by mode was turned off. Battery parameters include an electrical battery parameter which indicates the current charge or voltage level of the battery 12, e.g. a voltage value, and ambient temperature values, e.g. the actual temperature of the battery 12 or of other electrical components of the device 1, e.g. a processor temperature.

Furthermore, the battery status reports include in each case a time stamp with an indication of current date and time and preferably a device identifier, e.g. the personal emergency call device identifier 112 described above.

In step S11, the battery status report is transmitted via the mobile radio network 3 to the central service unit 2. For example, the battery status report is transmitted via various redundant communication channels, as described above in the context of accompanying alarm messages associated with an emergency call.

In step S12, the battery analyzer 22 of the computerized service unit 2 receives the status report and determines whether the status report indicates a deviation from expected battery data. A deviation is indicated, for example, by a difference of a battery parameter, included in the battery status report, from the value of this parameter, expected at the particular time indicated in the battery status report, e.g. a difference in voltage or temperature values for the respective point in time. Another example is a deviation of the average length of the battery recharging cycle, as defined by one or more battery status reports, from an expected length of the recharging cycle at the respective point in time. In case of a deviation exceeding a defined threshold value, processing continues in step S13; otherwise, in step S17.

In step S13, the battery analyzer 22 generates an alarm or warning message for the determined and identified deviation. For example, the voltage or charge level of the battery 12 decreases far more rapidly than expected or the recharging cycle is significantly shorter than expected.

In step S14, the battery analyzer 22 determines in a local database of the central service unit 2 emergency contact information, e.g. telephone numbers, e-mail addresses, etc., of parties associated with the device 1 that need to be notified about the respective deviation.

In steps S15a, S15b, the alarm or warning message are transmitted via the mobile radio network 3 or the telecommunications network 7, to the device 1 and identified emergency contacts 5.

In step S16, the emergency contacts 5 will initiate and perform any responsive actions for the device 1 or its user, respectively.

In step S17, the battery analyzer 22 stores in the central service unit 2 battery data 222 including the battery parameters received with the battery status report. Specifically, the battery analyzer 22 stores a time series of the electrical battery parameter. Depending on the embodiment, the battery analyzer 22 further stores in the time series event-related information received with the battery status report. In addition, the battery analyzer 22 derives and stores further battery data from the received battery status report. In an embodiment, rather than relying on event-related information from the device 1, the battery analyzer 22 derives event information from the received battery status reports and stores the derived information at the central service unit 2. For example, the battery analyzer 22 determines from an increase in the reported value of the electrical battery parameter that the battery 12 is being recharged at the device 1, e.g. based on a gradual increase of the reported voltage level, or that the battery 12 was installed (e.g. replaced) at the device 1, e.g. based on an abrupt and significant increase (jump) of the reported voltage level.

In step S18, the battery analyzer 22 determines from the stored battery data expected values for various battery parameters. Specifically, the battery analyzer 22 determines from the time series and recorded communication activity, e.g. the number of alarms transmitted, the time in stand-by and non-stand-by mode, as well as from the age and type of the battery 12, the expected value of the electrical battery parameter and also the expected average recharge cycle time.

Furthermore, the battery analyzer 22 determines from the current values of the electrical battery parameter and the ambient temperature the threshold value for determining a low battery level. Typical use patterns of a specific client or larger client groups can be used to determine this threshold value. Preferably, a safety margin is included in this calculation in order to continuously provide enough battery capacity in case of an emergency.

In step S19, the battery analyzer 22 determines whether the determined (e.g. temperature-dependent) threshold values have changed for the respective device 1. If applicable, in step S20, new threshold values are transmitted via the mobile radio network 3 to the device 1, where they are stored in step S21.

In step S22, the battery monitoring module 13 receives and stores the new threshold values in the device 1.

In step S23, the battery monitoring module 13 measures the current values of battery parameters, specifically the electrical battery parameter indicating the current charge or voltage level of the battery 12. Moreover, the battery monitoring module 13 compares the current value of the electrical battery parameter to the stored threshold value for determining a low battery level.

If the current value of the electrical battery parameter is below the stored threshold value, in step S24, the battery monitoring module 13 generates and transmits via the mobile radio network 3 a low battery alarm message to the central service unit 2.

In step S25, the battery analyzer 22 receives and stores in the time series associated with the battery 12 the low battery alarm. Furthermore, the battery analyzer 22 starts a timer for measuring the length of time expired from the time when the low battery alarm was generated (time stamp).

In step S27, the battery analyzer 22 determines whether, within a defined time interval after the low battery alarm, a battery status report is received in steps S26, S26′ that indicates that the battery 12 has been replaced (installed) or is being recharged, either by way of a battery change event, a battery recharge event, or an increase of the value of the electrical battery parameter, as described above. If such an indication is not received at the central service unit 2, within the defined time window, processing continues in step S28; otherwise steps S28, S29 are omitted.

In step S28, the battery analyzer 22 generates an alarm for a low battery at the device 1 which is not being recharged or replaced (installed).

In step S29, the battery analyzer 22 determines in the local database of the central service unit 2 emergency contact information of parties associated with the device 1 that need to be notified about the low battery.

In steps S30a, S30b, the low battery alarm message is transmitted via the mobile radio network 3 or the telecommunications network 7, to the device 1 and identified emergency contacts 5.

In step S31, the emergency contacts 5 will initiate and perform any responsive actions for the device 1 or its user, respectively.

It should be noted that, in the description, the computer program code has been associated with specific functional modules and the sequence of the steps has been presented in a specific order, one skilled in the art will understand, however, that the computer program code may be structured differently and that the order of at least some of the steps could be altered, without deviating from the scope of the invention.

1. A personal mobile emergency call device, comprising:
a subscriber identification module having stored therein a mobile subscriber identity for registering and identifying a user of the personal emergency call device in a mobile radio network; and
an alarm module configured to execute, on behalf of the user, an emergency call via the mobile radio network to a computerized central service unit;
a data store having stored therein a personal emergency call device identifier, and
the alarm module is further configured to transmit in association with the emergency call, automatically and with at least one of information redundancy and communication redundancy, to the central service unit via the mobile radio network the personal emergency call device identifier stored in the data store for identifying non-ambiguously the personal emergency call device which represents its user at the central service unit.

2. The personal emergency call device of claim 1, wherein the alarm module is configured to transmit the personal emergency call device identifier with communication redundancy by transmitting the personal emergency call device identifier to the central service unit via more than one communication channel comprising at least two of: a voice channel of the mobile radio network, a packet oriented data channel of the mobile radio network, a signaling channel of the mobile radio network, a Short Messaging Service of the mobile radio network, and an Unstructured Supplementary Service Data connection of the mobile radio network.

3. The personal emergency call device of claim 1, wherein the alarm module is configured to include in the emergency call a unique alarm identification number, to transmit the personal emergency call device identifier with communication redundancy by transmitting the personal emergency call device identifier to the central service unit via at least one different communicational channel than the emergency call, and to append to the personal emergency call device identifier the unique alarm identification number for assigning the emergency call at the central service unit to the personal emergency call device identifier.

4. The personal emergency call device of claim 1, wherein the alarm module is configured to transmit the personal emergency call device identifier with information redundancy by transmitting the personal emergency call device identifier to the central service unit encoded as tones via a voice channel of the mobile radio network and including redundant information for forward error correction.

5. A computerized service unit, comprising:
an alarm processor configured to receive from a personal mobile emergency call device via a mobile radio network an emergency call on behalf of a user of the personal emergency call device, the user being registered in the mobile radio network with a mobile subscriber identity provided by the personal emergency call device;
wherein the alarm processor is further configured to receive via the mobile radio network a personal emergency call device identifier transmitted, automatically and with at least one of information redundancy and communication redundancy, by the personal emergency call device to the computerized service unit in association with the emergency call, and to identify non-ambiguously the personal emergency call device representing its user using the personal emergency call device identifier.

6. The computerized service unit of claim 5, wherein the alarm processor is further configured to receive the personal emergency call device identifier with communication redundancy by receiving the personal emergency call device identifier via more than one communication channel comprising at least two of: a voice channel of the mobile radio network, a packet oriented data channel of the mobile radio network, a signaling channel of the mobile radio network, a Short Messaging Service of the mobile radio network, and an Unstructured Supplementary Service Data connection of the mobile radio network.

7. The computerized service unit of claim 5, wherein the alarm processor is further configured to receive the personal emergency call device identifier with communication redundancy by receiving the personal emergency call device identifier via at least one different communicational channel than the emergency call, and to assign the emergency call to the personal emergency call device identifier using a unique alarm identification number which is included in the emergency call and appended to the personal emergency call device identifier.

8. The computerized service unit of claim 5, further comprising a plurality of dial-in nodes, each dial-in node having assigned thereto one or more personal emergency call devices, and being configured in each case to define a value for one or more digits of a calling number assigned to one of the personal emergency call devices upon receiving the emergency call from the one of the personal emergency call devices.

9. A method of identifying at a computerized central service unit a caller of an emergency call received via a mobile radio network from a personal mobile emergency call device on behalf of the caller, the caller being registered in the mobile radio network with a mobile subscriber identity provided by the personal emergency call device, wherein the method comprises:
receiving at the computerized central service unit via the mobile radio network a personal emergency call device identifier transmitted to the computerized central service unit, automatically and with at least one of information redundancy and communication redundancy, by the personal emergency call device in association with the emergency call; and
identifying non-ambiguously the caller of the emergency call, using the personal emergency call device identifier.

10. The method of claim 9, wherein the personal emergency call device identifier is received at the computerized central service unit with communication redundancy by receiving the personal emergency call device identifier via more than one communication channel comprising at least two of: a voice channel of the mobile radio network, a packet oriented data channel of the mobile radio network, a signalling channel of the mobile radio network, a Short Messaging Service of the mobile radio network, and an Unstructured Supplementary Service Data connection of the mobile radio network.

11. The method of claim 9, wherein the personal emergency call device identifier is received at the computerized central service unit with communication redundancy by receiving the personal emergency call device identifier via at least one different communicational channel than the emergency call; and the emergency call is assigned at the central service unit to the personal emergency call device identifier using a unique alarm identification number which is included in the emergency call and appended to the personal emergency call device identifier.

12. The method of claim 9, wherein values of one or more defined digits of a calling number are set at the computerized central service unit depending on over which one of a plurality of dial-in nodes the emergency call was received at the computerized central service unit.

13. A computer program product comprising a non-transitory computer readable medium having stored thereon computer program code which directs a personal mobile emergency call device to:
execute on behalf of a user of the personal emergency call device an emergency call via a mobile radio network to a computerized central service unit, the user being registered in the mobile radio network with a mobile subscriber identity stored in a subscriber identification module of the personal emergency call device; and
transmit in association with the emergency call, automatically and with at least one of information redundancy and communication redundancy, to the central service unit via the mobile radio network a personal emergency call device identifier stored in the personal emergency call device for identifying non-ambiguously the personal emergency call device which represents its user at the central service unit.

14. A computer program product comprising a non-transitory computer readable medium having stored thereon computer program code which directs a computerized service unit to:
receive from a personal mobile emergency call device via a mobile radio network an emergency call on behalf of a user of the personal emergency call device, the user being registered in the mobile radio network with a mobile subscriber identity provided by the personal emergency call device;
receive via the mobile radio network a personal emergency call device identifier transmitted, automatically and with at least one of information redundancy and communication redundancy, by the personal emergency call device to the computerized central service unit in association with the emergency call; and
identify non-ambiguously the personal emergency call device and its user using the personal emergency call device identifier.
